(19) United States
(12) Patent Application Publication
(10) Pub. No.: US 2015/0066605 A1
(43) Pub. Date: Mar. 5, 2015

(54) METHOD AND SYSTEM FOR TOLL PAYMENT SERVICE

(71) Applicant: Rent A Toll, Ltd., Carrollton, TX (US)

(72) Inventors: Sarath K. Balachandran, Irving, TX (US); Anand Shanmuga Sundaram, Irving, TX (US)

(21) Appl. No.: 14/471,300

(22) Filed: Aug. 28, 2014

Related U.S. Application Data
(60) Provisional application No. 61/874,053, filed on Sep. 5, 2013.
(60) Provisional application No. 61/872,026, filed on Aug. 30, 2013.

(51) Int. Cl. G07B 15/02; G06Q 30/06

(52) U.S. Cl. CPC G07B 15/02; G06Q 30/0645
USPC 705/13

(57) ABSTRACT

A method for providing a toll payment service, the method includes establishing, by a renter, a toll payment account with a vehicle operator via a third-party entity, providing, to the renter, a toll payment service option, and determining whether the renter has accepted the toll payment service option. Responsive to a determination that the renter has accepted the toll payment service option, adding toll-usage credit to the toll payment account of the renter for an amount based upon anticipated needs of the renter prior to toll usage. The toll-usage credit from the toll payment account is utilized for paying one or more toll authorities for toll usage.

### CROSS-REFERENCE TO RELATED APPLICATIONS

This patent application claims priority from, and incorporates by reference the entire disclosure of, U.S. Provisional Patent Application No. 61/872,026, filed Aug. 30, 2013 and U.S. Provisional Patent Application No. 61/874,053, filed Sep. 5, 2013.

### BACKGROUND

1. Technical Field

The present invention relates generally to toll payment systems and methods and, more particularly, but not by way of limitation, to systems and methods for providing anticipated prepaid toll payment services and/or post-paid toll payment services to users of vehicles operated by, for example, fleet operators or a rental-car agencies during a rental period.

2. History of Related Art

The crowding of highways within metropolitan areas has resulted in the development of additional traffic arteries known as toll roads. Toll roads have become increasingly popular, however, they require the payment of a toll fee for use by vehicular occupants. The collection of tolls by conventional means has had a negative effect upon highway throughput and safety. Congestion and long backups on toll plazas are becoming more common. Such conditions involve a significant economic cost, through lost time and reduced productivity. Moreover, serious accidents at toll plazas, caused by operators or mechanical failures, have also increased in frequency.

### SUMMARY OF THE INVENTION

A method for providing a toll payment service, the method includes establishing, by a renter, a toll payment account with a vehicle operator via a third-party entity, providing, to the renter, a toll payment service option, and determining whether the renter has accepted the toll payment service option. Responsive to a determination that the renter has accepted the toll payment service option, adding toll-usage credit to the toll payment account of the renter for an amount based upon anticipated needs of the renter prior to toll usage. The toll-usage credit from the toll payment account is utilized for paying one or more toll authorities for toll usage.

An article of manufacture for providing a toll payment service, the article of manufacture includes at least one computer readable medium and processor instructions contained on the at least one computer readable medium, the processor instructions configured to be readable from the at least one computer readable medium by at least one processor and thereby cause the at least one processor to establish, by a renter, a toll payment account with a vehicle operator via a third-party entity, provide, to the renter, a toll payment service option, and determine whether the renter has accepted the toll payment service option. Responsive to a determination that the renter has accepted the toll payment service option, add toll-usage credit to the toll payment account of the renter for an amount based upon anticipated needs of the renter prior to toll usage. The toll-usage credit from the toll payment account is utilized for paying one or more toll authorities for toll usage.

A system includes a third-party entity interoperably connected to a toll authority and a toll-rental entity. A processor of the third-party entity is configured to establish, by a renter, a toll payment account with the third-party entity, provide, to the renter, a toll payment service option, and determine whether the renter has accepted the toll payment service option. Responsive to a determination that the renter has accepted the toll payment service option, add toll-usage credit to the toll payment account of the renter for an amount based upon anticipated needs of the renter prior to toll usage. The toll-usage credit from the toll payment account is utilized for paying the toll authority for toll usage.

### BRIEF DESCRIPTION OF THE DRAWINGS

A more complete understanding of the method and system of the present invention may be obtained by reference to the following Detailed Description when taken in conjunction with the accompanying Drawings wherein:

FIG. 1 illustrates a perspective view illustrating an exit of a toll road;

FIG. 2 illustrates a control device installed on an electronic toll collection lane;

FIG. 3A illustrates a block diagram of a toll payment system in accordance with an embodiment;

FIG. 3B illustrates a block diagram of a toll payment system in accordance with an alternate embodiment;

FIG. 4A illustrates a block diagram of a wireless toll payment system utilized in conjunction with an embodiment;

FIG. 4B illustrates of a wireless toll payment system utilized in conjunction with an alternate embodiment;

FIG. 5A is a flow illustrating a process for providing a toll payment service;

FIG. 5B illustrates an exemplary messaging diagram in accordance with an embodiment; and

FIG. 6 is a schematic view illustrating processing circuitry of components of the toll payment system.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

Today, users of vehicles operated by, for example, a fleet operator or a rental-car agency who use toll roads are responsible to pay toll authorities for the toll usage. As such, users are prone to the purchase of, for example, a toll tracking device or setup an account with toll authorities to pay for toll usage. For example, the toll tracking device allows the users to bypass cash only toll gate and, in many instances, the vehicle can maintain its normal speed as it traverses the toll gate wherein the passage of the toll fee tracking device is recorded. Popularity of the toll tracking device has expanded to a point that a normal user of the toll tracking device can be frustrated by the lines at toll gates when the toll fee tracking device is not available. Unavailability of the toll tracking device can be for numerous reasons, not the least of which is the use of rental cars. However, if the users do not pre-arrange the payment agreement with toll authorities and use the toll roads, the users get billed by the toll authorities for the toll usage along with additional fines and processing charges.

Alternately, users of vehicles operated by, for example, a fleet operator or a rental-car agency that use toll roads may also purchase, for example, a prepaid toll service that allows the users to use the toll roads for a fixed daily subscription fee. Processes such as those described above are more convenient and economical for users who use the toll roads extensively; however, the processes described above are not suitable for users who use the toll road infrequently. In order to satisfy the requirements of infrequent toll road users, a flexible toll payment service is needed that provides flexibility to users to make their own judgment for the amount of money they prefer to allocate for toll expense during a rental period. For example, the rental period may be a duration for which a user desires to rent a vehicle such as, for example, a day, a week, a month, a year, and the like.

In a typical embodiment, users of vehicles operated by, for example, a fleet operator or a rental-car agency may setup a toll payment account with the fleet operator or the rental-car agency and fund the toll account. The funds from the toll payment account are utilized for paying the toll authorities for toll usage during the rental period. For example, the toll payment account may be used for payment for anticipated future toll usage in order to avoid additional fines and processing charges from the toll authorities or the fleet operators. The users may also pay for the toll usage upon returning the vehicles to the fleet operators for toll usage during the rental period.

In a typical embodiment, the flexible pre-paid toll payment service is a toll service for which a credit is purchased in advance of toll usage. The purchased credit is added to a user's toll payment account that was setup with the fleet operator or the rental-car agency. The purchased credit varies based upon the anticipated needs of individuals. For example, an individual who rents a vehicle for three days and anticipates using the toll roads infrequently may decide to purchase credit for $5. Alternately, an individual who rents a vehicle for seven days and anticipates using the toll roads frequently may decide to purchase credit for $25. The purchased credit is used to pay for using toll roads operated by various toll authorities throughout the country. The purchased credit is non-refundable and is valid for the duration of the rental period. The payment for the purchased credit could be made upfront to the rental car agency or the fleet operator for future toll usage. Exemplary embodiments allow individuals to make a decision on the amount of money the individual will pay to the rental car agency or the fleet operator. The rental car agency or the fleet operator will use the money from the individuals to pay the toll authorities for the individual's toll usage.

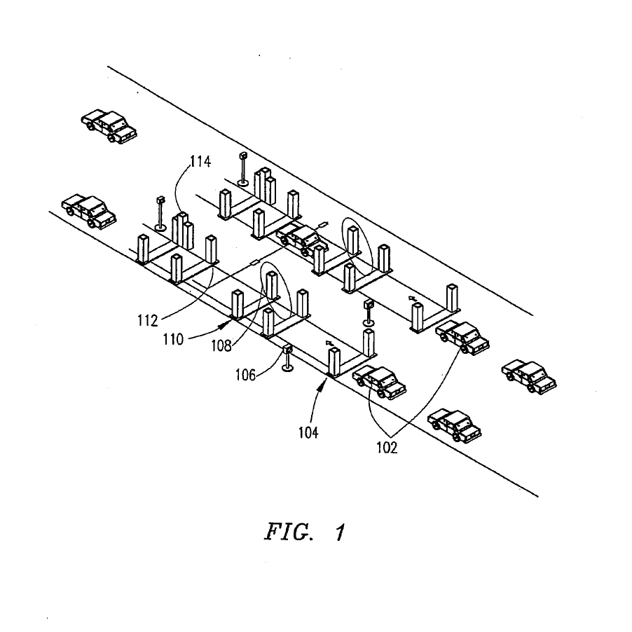

FIG. 1 illustrates two Electronic Toll Collection (ETC) lanes 102. In each of the ETC lanes 102, tolls are automatically collected from each vehicle along the lanes 102 through toll collection techniques such as, for example, radio communication between a toll tracking device (e.g., a radio frequency integrated device (RFID) transponder) and a toll collection unit installed on each ETC lane 102, license plate recognition techniques, and the like. The toll collection units are typically owned by a toll authority and are situated on toll authority property. Those skilled in the art will appreciate that the exemplary embodiments can be practiced in connection with roadways having additional lanes, including multi-lane divided highways, bridges, and tunnels. As one skilled in the art will appreciate the invention can also be practiced in connection with numerous other transport systems such as, for example, railways and waterways.

On each ETC lane 102, a vehicle type identifying device 104, a license plate monitor camera 106, an antenna 108, a vehicle detector 110, and a display 112 are arranged. The vehicle type identifying device 104 identifies the type of a vehicle passing thereby. The license plate monitor camera 106 captures an image of a license plate of the vehicle to read a license plate number out of the image. The vehicle detector 110 may be, for example, a photoelectric cell for optically sensing the presence of a vehicle and generating a VEHICLE PRESENT signal.

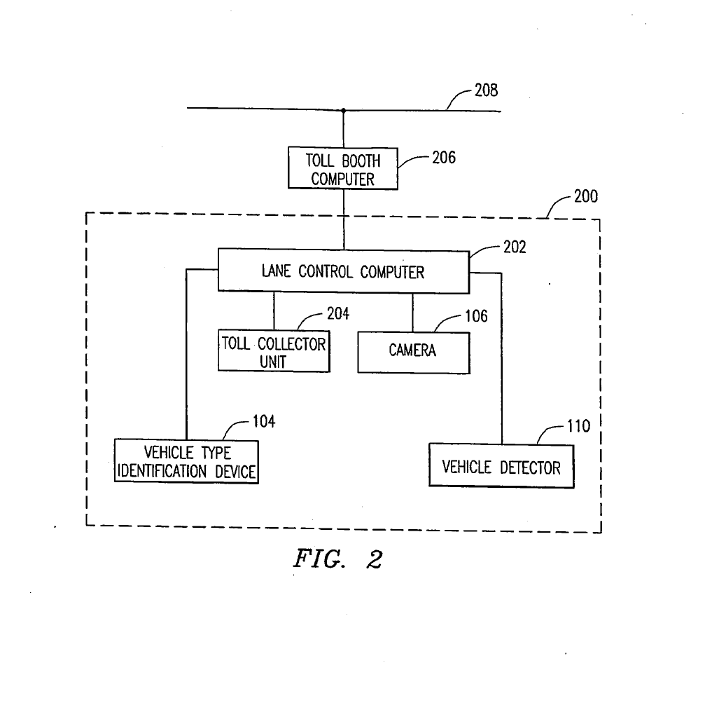

The automatic toll collection system includes a control device 200, as shown in FIG. 2, one for each ETC lane 102. The control device 200 has a lane control computer 202 which controls operations of the vehicle type identifying device 104, the license plate monitor camera 106, and a toll collecting unit 204. The control device 200 receives information signals from the vehicle detector 110 indicating the passing of the vehicle. The lane control computer communicates with a toll booth computer 206. The toll booth computer 206 communicates with a network 208 for transmission of information.

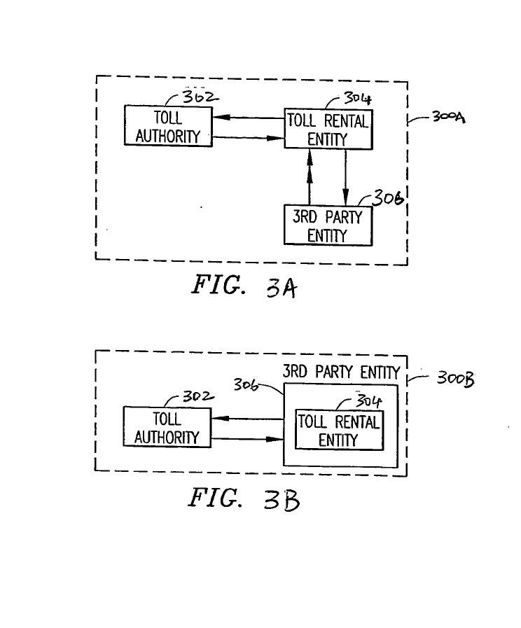

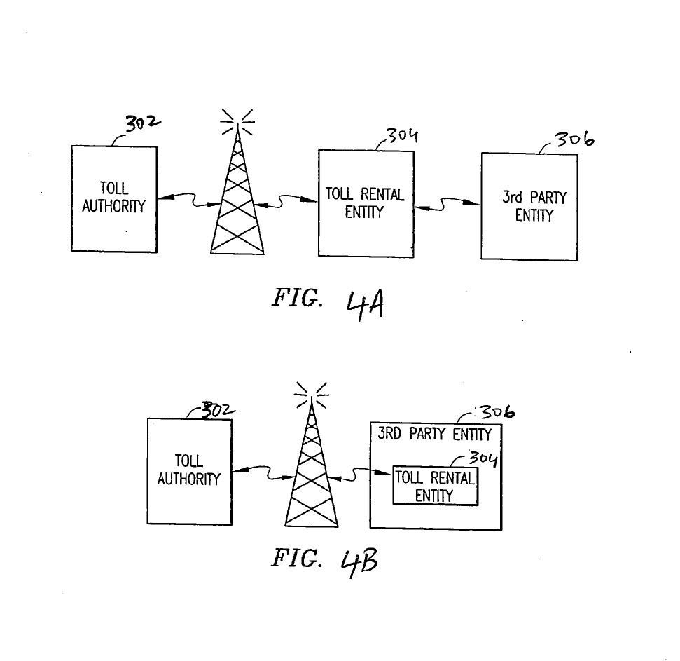

FIG. 3A illustrates a block diagram 300A of a toll payment system in accordance with an embodiment. The system 300A includes a toll authority 302, a toll-rental entity 304, and a third-party entity 306. The toll-rental entity 304 interfaces with both a toll authority 302 and a third-party entity 306. In a typical embodiment, the toll-rental entity 304 acts as a communication channel between the toll authority 302 and the third-party entity 306 for forwarding data from the toll authority 302 to the third-party entity 306 in, for example, real-time, near real-time, or at regular predetermined intervals.

In a typical embodiment, the third-party entity 306 may be, for example, a fleet operator, a rental-car agency, a transport rental company, a transport leasing company, and the like. The third-party entity 30 may also be a standalone Kiosk Terminal at a third-party entity location, a standalone website online service, part of a third-party entity's point-of-sale (POS) system, part of a third-party entity's online website, part of a third-party entity's smartphone application, standalone smartphone application, and In-vehicle computer application, a telephone service, an Interactive Voice Response (IVR) service, an electronic mail (E-mail) service, a text message service, a messaging service, and the like. The third-party entity 306 is configured to provide users of their vehicles an option to enroll in the flexible pre-paid toll payment service at the time of renting a vehicle. In a typical embodiment, the flexible pre-paid toll payment service is a toll service for which a credit is purchased in advance of toll usage. The purchased credit varies based upon the anticipated needs of individuals. The flexible pre-paid toll payment service provides flexibility to rental vehicle users to make their own judgment for the amount of money they prefer to allocate for toll expense during their rental period. For example, an individual who rents a vehicle for three days and anticipates using the toll roads infrequently may decide to purchase a credit for $7 for future toll usage. Alternately, an individual who rents a vehicle for over a week and anticipates using the toll roads frequently may decide to purchase a credit for $40 for future toll usage. The purchased credit is used to pay for using toll roads operated by various toll authorities throughout the country. The purchased credit is non-refundable and is valid for the duration of the rental period.

In a typical embodiment, an individual may purchase, at the time of renting the vehicle, credit for future toll usage. The purchased credit is added to the individual's toll payment account that was setup with the third-party entity 306 and depends upon the anticipated needs of the individual. The third-party entity 306 also charges a processing fee for providing the flexible pre-paid toll payment service. For example, if the individual purchases, at the time of renting the vehicle, only a $5 credit for future toll usage, the individual may end up paying an additional $3 in processing fees. According to exemplary embodiments, individuals are able to reload their credit at any time during the rental period using a variety of payment methodologies. The payment methodologies may include, for example, calling the third-party entity 306 to reload, accessing an account at a website of the third-party entity 306, accessing an account using a third-party entity 306 application via a communication device, accessing an account using a third-party entity 306 application via an on-board computer within the vehicle, and the like. In a typical embodiment, the communication device may be, for example, a desktop computer, a smartphone, a laptop computer, a tablet computer, and the like.

The processing fees are set by the third-party entity 306 and may differ depending on various instances. As referenced above, if the individual purchases, at the time of renting the vehicle, only a $5 credit for future toll usage, the individual may end up paying $3 in processing fees. However, if the individual purchases, at the time of renting the vehicle, $25 credit for future toll usage, the individual may end up paying only $2 in processing fees. Alternately, if the individual decides to reload their credit at any time prior to exhausting the initially purchased credit, the third-party entity 306 may charge a processing fee of, for example, $5. In situations, when a customer decides to reload their credit at any time after exhausting the initially purchased credit, the third-party entity 306 may charge a higher processing fee of, for example, $10.

When a vehicle enrolled in the flexible pre-paid toll payment service passes a toll gate of the toll authority 302, the toll authority 302 collects data using methodology such as, for example, RFID transponder reader, license plate recognition, and the like. The data which includes information related to the toll fee charged to the vehicle may be passed from the toll-rental entity 302 to the third-party entity 304 via the toll-rental entity 304 in real-time or near real-time such that the third-party entity 304 utilizes the individual's purchased credit to pay for the toll related charges. In short, the toll-rental entity 304 acts as a communication channel between the toll authority 302 and the third-party entity 306 for forwarding data from the toll authority 302 to the third-party entity 306 in a real-time, near real-time fashion, or at regular predetermined intervals.

FIG. 3B illustrates an alternate embodiment of the toll payment system 300B in accordance with an alternate embodiment in which the toll-rental entity 304 may be integrated into an existing operating system of the third-party entity 306.

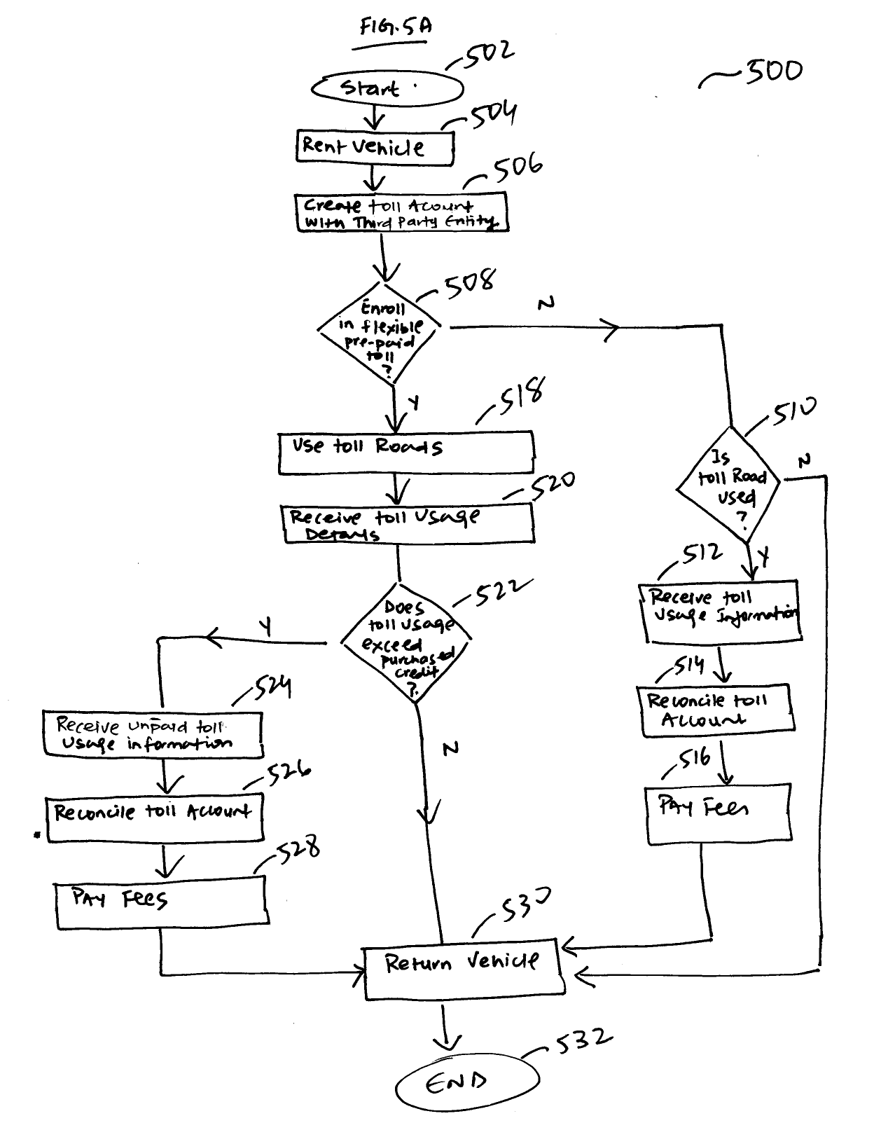

FIGS. 4A-4B illustrates a block diagram of a wireless toll payment system utilized in conjunction with the present invention. Although all portions of the system of FIGS. 4A and 4B are shown communicating via wireless links, it will understood by one skilled in the art that one or more portions of the system may be communicated via a wired network or other technology.

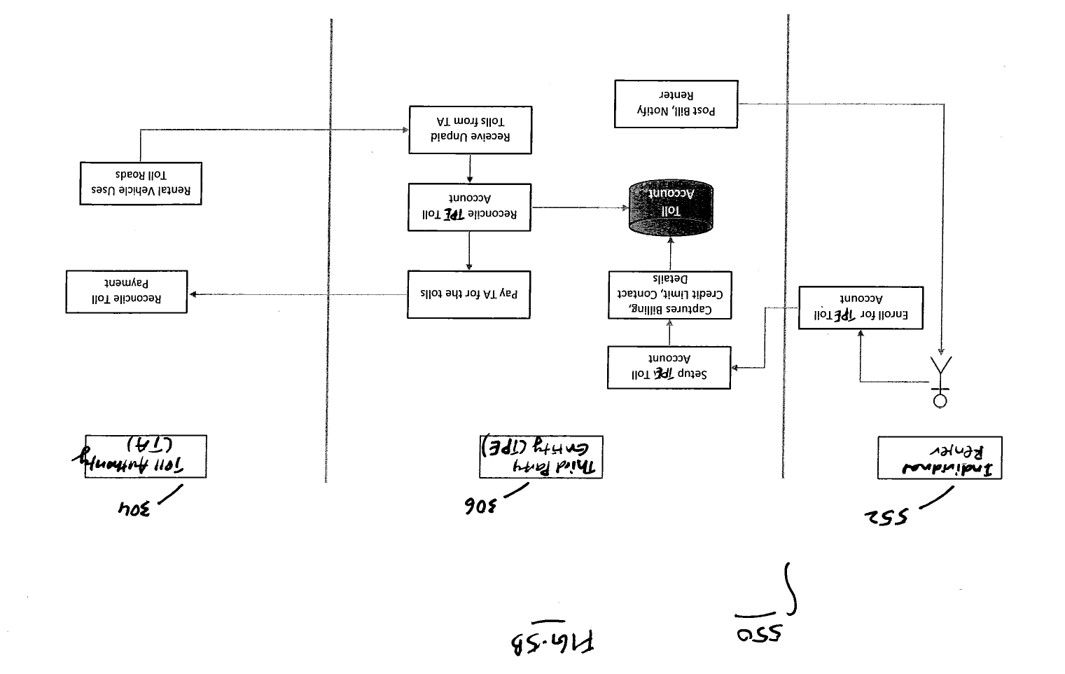

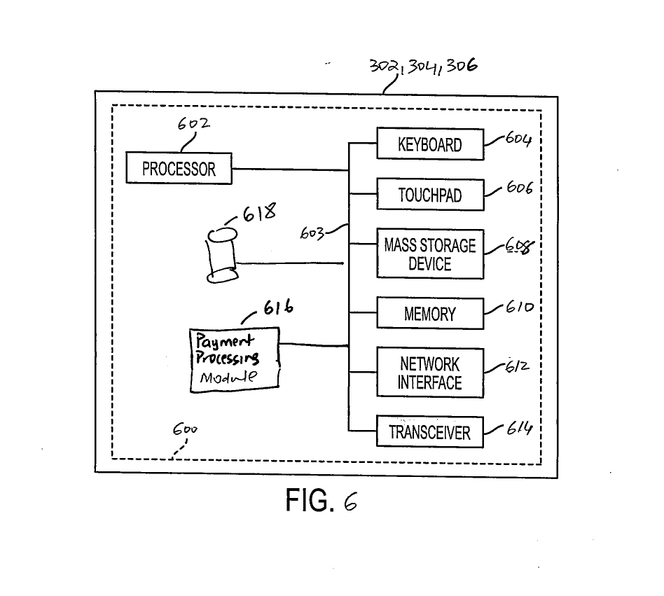

FIG. 5A illustrates in detail a process flow 500 in accordance with an exemplary embodiment. Although steps of the flow 500 are depicted in a particular sequence, it will be appreciated by persons of ordinary skill in the art that certain steps of the process need not necessarily follow a strict sequence but can be rearranged and/or performed simultaneously. For illustrative purposes, the process 500 will be described relative to FIGS. 1-4B. The process 500 starts at step 502. At step 504, an individual rents a vehicle (renter) operated by, for example, a fleet operator or a rental-car agency. At step 506, a toll account is created for the individual. In a typical embodiment, the toll account is created and maintained by the third-party entity 306 and may be used for payment for anticipated future toll usage. Individuals may also pay for the toll usage upon returning the vehicles to the third-party entity 306.

At the time of renting the vehicle, the individual is offered an option to enroll in a flexible pre-paid toll payment service. In a typical embodiment, the flexible pre-paid toll payment service is a toll payment service for which a credit is purchased in advance of toll usage. The purchased credit depends upon the anticipated needs of individuals. The flexible pre-paid toll payment service provides flexibility to rental vehicle users to make their own judgment for the amount of money they prefer to allocate for toll expense during their rental period. At step 508, the third-party entity 306 determines whether the individual has accepted the option to enroll in the flexible pre-paid toll payment service. If it is determined at step 508 that the individual has declined to enroll in the flexible pre-paid toll payment service, the process 500 proceeds to step 510. At step 510, it is determined whether the individual in the rented vehicle has used toll roads. If it is determined at step 510 that the individual in the rented vehicle has not used toll roads, the process proceeds to step 530. At step 530, the individual returns the vehicle to the fleet operator. From step 530, the process 500 ends at step 532.

However, if it is determined at step 510 that the individual in the rented vehicle has used toll roads, the process proceeds to step 512. At step 512, the third-party entity 306 receives toll usage information from the toll authority 302. The toll usage information may be, for example, toll usage date, toll usage time, toll usage amount, and the like for individuals in rented vehicles who declined to enroll in the flexible pre-paid toll payment service. At step 514, the third-party entity 306 reconciles the toll account for the individual. In a typical embodiment, the third-party entity 306 charges the individual for each toll transaction along with a transaction fee per toll transaction. For example, if the individual uses the toll roads three times during the duration of the rental period incurring $10 in toll charges, the third-party entity 306 charges the individual $10 for toll charges along with $2 for every time the individual uses the toll road. In alternate embodiments, the third-party entity 306 may charge the individual $10 for toll charges along with a $25 daily administrative fee. At step 516, the individual pays the third-party entity 306 and the third-party entity 306 pays the toll authority 302. At step 530, the individual returns the vehicle to the third-party entity 306. From step 530, the process 500 ends at step 532.

However, if it is determined at step 508 that the individual has accepted to enroll in the flexible pre-paid toll payment service, the process 500 proceeds to step 518. At step 518, the individual in the rented vehicle uses the toll roads. At step 520, the third-party entity 306 receives toll usage information from the toll authority 302 directly or via the toll-rental entity 304. The toll usage information may be, for example, toll usage date, toll usage time, toll usage amount, and the like for individuals in rented vehicles who enrolled in the flexible pre-paid toll payment service. At step 522, it is determined whether the toll usages charges incurred by the individual exceed the purchased credit. If it is determined at step 522 that the toll usage charges incurred by the individual do not exceed the purchased credit, the process 500 proceeds to step 530. At step 530, the individual returns the vehicle to the fleet operator. From step 530, the process 500 ends at step 532.

However, if it is determined at step 522 that the toll usage charges incurred by the individual exceed the purchased credit, the process 500 proceeds to step 524. At step 524, the third-party entity 306 receives toll usage information from the toll authority 302. The toll usage information may be, for example, toll usages charges incurred by the individual after exceeding the purchased credit. At step 526, the third-party entity 306 reconciles the toll account for the individual. In a typical embodiment, the third-party entity 306 charges the individual for each additional toll transaction along with a transaction fee per toll transaction. For example, if the individual uses the toll roads three additional times during the duration of the rental period incurring $10 in toll charges, the third-party entity 306 charges the individual $10 for toll charges along with $2 for every time the individual uses the toll road. In alternate embodiments, the third-party entity 306 may charge the individual $10 for toll charges along with a $25 daily administrative fee. At step 528 the individual pays the third-party entity 306 and the third-party entity 306 pays the toll authority 302. At step 530, the individual returns the vehicle. From step 530, the process 500 ends at step 532.

FIG. 5B illustrates an exemplary messaging diagram 550 depicting message flow between the toll authority 302, the third-party entity 306, and an individual renting a vehicle. Although the message flow is depicted in a particular sequence, it will be appreciated by persons of ordinary skill in the art that message flow need not necessarily follow a strict sequence but can be rearranged and/or performed simultaneously. For illustrative purposes, the messaging diagram 550 has been described above with respect to FIGS. 1-5A.

FIG. 6 is a schematic view illustrating processing circuitry 600 of the toll authority 302, the toll-rental entity 304, and the third-party entity 306. The processing circuitry 600 includes a processor 602 connected to a bus 603. The bus 603 serves as a connection channel between the processor 602 and various other components of the toll authority 302, the toll-rental entity 304, and the third-party entity 306. User input/output devices such as, for example, a keyboard 604 and touchpad 606, are coupled to the processor 602. Further examples of input/output devices may include touchscreens, pointing trackballs, trackpads, and a variety of other input/output devices. Programs and data are stored on a mass storage device 608, coupled to the processor 602. Examples of the mass storage device 608 may include, for example, hard discs, optical disks, magneto-optical discs, solid-state storage devices, and a variety of other mass storage devices.

A system memory 610 is coupled to the processor 602 to provide the processor 602 with fast storage to facilitate execution by the processor 602. Examples of system memory 610 may include, for example, random access memory (RAM) devices such as dynamic RAM (DRAM), synchronous DRAM (SDRAM), solid state memory devices, and a variety of other memory devices. A network interface 212 is coupled to the processor 602. The network interface 612 is configured to establish network connection. In a typical embodiment, the network interface 612 is configured to communicate via for example, the Internet. The processing circuitry 600 also includes a transceiver 614 for receiving and transmitting data and a payment processing module 616. The payment processing module 616 may include, for example, at least one rental point-of-sale (POS) terminal and at least one invoice unit. The processing circuitry 600 also includes a database 618 for data storage. The database can be, for example, an Oracle™ database, a MS Access™ database, MS SQL, IBM DB2, and the like.

Exemplary embodiments provide an option for the individuals renting a vehicle operated by, for example, a fleet operator or a rental-car agency to pay for the anticipated unpaid toll charges incurred during the rental period on the rental vehicle to eliminate additional charges such as, for example, administrative fees and fines on the toll roads for unpaid toll charges.

In addition, various embodiments provide improved performance, reliability and overall economics of automated individual's highway toll service utilization on the rental vehicle and automation of toll payment processing with the toll authorities for the unpaid tolls for the fleet operator's vehicle.

Furthermore, various embodiments provide a system for monitoring and reporting an individual's anticipated toll service enablement option for the fleet operator, receiving payment from the individual renting the vehicle, receiving payment authorization for post payment charges, establishing interface with the toll authorities, issuing agency, moving citation issuer for the fleet operator unpaid moving citations, making payment for the unpaid moving citations, determining individuals responsible for the moving citation, charging individuals by deducting anticipated toll payment received from the individual and/or charges individual's pre-authorized payment source, notifying the individual for the individual's moving citation activity and or payment updates, optionally may fully or partially issue a refund on individual's anticipated toll payment with processing fees deducted.

Additionally, various embodiments provide a system and method for individual rental vehicle renters, individuals of a third-party vehicle owned or managed by, for example, vehicle operator or rental car agency, to pay the third-party entity for the anticipated toll usage during the rental period to eliminate additional charges such as, for example, administrative fees and fines for unpaid tolls. Individuals may authorize payment for the anticipated toll usage during at least one of, for example, a vehicle reservation time, a vehicle check-out time, a vehicle check-in time and during a vehicle rental time.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1. A method for providing a toll payment service, the method comprising:
utilizing at least one processor to perform the following:
establishing, by a renter, a toll payment account with a vehicle operator via a third-party entity;
providing, to the renter, a toll payment service option;
determining whether the renter has accepted the toll payment service option;
responsive to a determination that the renter has accepted the toll payment service option, adding toll-usage credit to the toll payment account of the renter for an amount based upon anticipated needs of the renter prior to toll usage; and
wherein the toll-usage credit from the toll payment account is utilized for paying one or more toll authorities for toll usage.

2. The method of claim 1, wherein the toll payment service option provides flexibility to the renter to purchase the toll-usage credit based upon anticipated toll road usage.

3. The method of claim 1, wherein the toll-usage credit allows the renter to utilize toll roads.

4. The method of claim 1, wherein, responsive to the adding step, charging a processing fee for the toll payment service.

5. The method of claim 1, wherein the processing fee varies based on a toll-usage credit amount purchase.

6. The method of claim 5, wherein:
charging a lower processing fee in response to a higher toll-usage credit amount purchase; and
charging a higher processing fee in response to a lower toll-usage credit amount purchase.

7. The method of claim 1 further comprising reloading the toll-usage credit any time during a rental period, wherein the reloading requires payment of a variable processing fee.

8. The method of claim 7, wherein the reloading is performed via at least one of calling the pre-paid toll service provider, accessing the toll account at a website of the pre-paid toll service, accessing the toll account using a pre-paid toll service application via a communication device, and accessing the toll account using a pre-paid toll service application via an on-board computer within the vehicle.

9. The method of claim 7, wherein:
if the reloading is performed prior to exhausting previously purchased toll-usage credit, charging a lower processing fee; and
if the reloading is performed after exhausting the previously purchased toll-usage credit, charging a higher processing fee.

10. The method of claim 7, wherein the toll payment service option is provided to the renter by the third-party entity.

11. The method of claim 10, wherein the third-party entity comprises at least one of a fleet operator, a rental-car agency, a transport rental company, a standalone Kiosk Terminal, and a transport leasing company.

12. The method of claim 11, wherein the third-party entity communicates with the one or more toll authorities via a toll-rental entity.

13. The method of claim 12, wherein the toll-rental entity acts as a communication channel between the one or more toll authorities and the third-party entity and is configured to forward data from the one or more toll authorities to the third-party entity.

14. The method of claim 13, wherein the data comprises toll usage data.

15. The method of claim 1 wherein, responsive to a determination that the renter has not accepted the toll payment service option, performing the following:
determining whether the renter has used toll roads;
responsive to a determination that the renter has used the toll roads, charging, the renter, toll transaction charges and transaction fees for each toll transaction upon return of the vehicle; and
responsive to a determination that the renter has not used the toll roads, return the vehicle.

16. The method of claim 1 further comprising:
incurring toll transaction charges by utilizing toll roads;
determining whether the incurred toll transaction charges exceed the previously purchased credit;
responsive to a determination that the incurred toll transaction charges exceed the previously purchased credit, charging, the renter, additional toll transaction charges and transaction fees for each toll transaction upon return of the vehicle; and
responsive to a determination that the incurred toll transaction charges do not exceed the previously purchased credit, return the vehicle.

17. The method of claim 1, wherein the toll payment account comprises at least one of a pre-paid toll payment account and a post-paid toll payment account.

18. The method of claim 1, wherein the creating the toll payment account is performed by the third-party entity.

19. An article of manufacture for providing a toll payment service, the article of manufacture comprising:
at least one computer readable medium;
processor instructions contained on the at least one computer readable medium, the processor instructions configured to be readable from the at least one computer readable medium by at least one processor and thereby cause the at least one processor to operate as to:
establish, by a renter, a toll payment account with a vehicle operator via a third-party entity;
provide, to the renter, a toll payment service option;
determine whether the renter has accepted the toll payment service option;
responsive to a determination that the renter has accepted the toll payment service option, add toll-usage credit to the toll payment account of the renter for an amount based upon anticipated needs of the renter prior to toll usage; and
wherein the toll-usage credit from the toll payment account is utilized for paying one or more toll authorities for toll usage.

20. The article of manufacture of claim 19, wherein the toll payment service option provides flexibility to the renter to purchase the toll-usage credit based upon anticipated toll road usage.

21. The article of manufacture of claim 19, wherein the toll-usage credit allows the renter to utilize toll roads.

22. The article of manufacture of claim 19, wherein, responsive to the adding step, charging a processing fee for the toll payment service.

23. A system comprising:
a third-party entity interoperably connected to a toll authority and a toll-rental entity;
wherein a processor of the third-party entity is configured to:
establish, by a renter, a toll payment account with the third-party entity;
provide, to the renter, a toll payment service option;
determine whether the renter has accepted the toll payment service option;
responsive to a determination that the renter has accepted the toll payment service option, add toll-usage credit to the toll payment account of the renter for an amount based upon anticipated needs of the renter prior to toll usage; and
wherein the toll-usage credit from the toll payment account is utilized for paying the toll authority for toll usage.

24. The system of claim 23, wherein the toll-rental entity is a stand-alone unit from the third-party entity.

25. The system of claim 23, wherein the toll-rental entity is integrated within the third-party entity.
